(19) United States
(12) Patent Application Publication
(10) Pub. No.: US 2017/0233121 A1
(43) Pub. Date: Aug. 17, 2017

(54) Method for preserving produce

(71) Applicant: Scarlett Martel, Sherrington (CA)

(72) Inventor: Scarlett Martel, Sherrington (CA)

(21) Appl. No.: 15/424,790

(22) Filed: Feb. 4, 2017

(30) Foreign Application Priority Data
Feb. 12, 2016 (GB) 1602597.5

(51) Int. Cl. B65B 31/02; A23B 7/148; B65B 51/10; A23B 7/04; B65B 7/28; B65B 25/00

(52) U.S. Cl. CPC B65B 31/02; B65B 7/2878; B65B 25/001; B65B 51/10; A23B 7/0425; A23B 7/148; A23V 2002/00

(57) ABSTRACT

A method, comprising steps: (a) placing a plurality of produce in an airtight chamber having a quantity of air and a first pressure, wherein the plurality of produce comprises water; (b) removing the quantity of air via a first vacuum pump to reduce the first pressure in the airtight chamber providing a vacuum cooling effect, wherein the water evaporates until the plurality of produce reaches a predetermined temperature; (c) packaging each individual produce of the plurality of produce in a container, wherein the container has a second pressure; (d) reducing the second pressure via a second vacuum pump; and (e) injecting a nitrogen gas inside the container until the container reaches a third pressure.

### CROSS-REFERENCE TO RELATED APPLICATIONS

The present application claims priority to United Kingdom Patent Application serial number UK1602597.5, filed on Feb. 12, 2016 entitled “Method for preserving produce by packaging using cold and low pressure Nitrogen gas”, the disclosure of which is hereby incorporated in its entirety at least by reference.

### BACKGROUND OF THE INVENTION

1. Field of the Invention

The present invention relates to food preservation, but more particularly to a method for preserving produce by vacuum cooling and packaging using cooled down low pressure Nitrogen gas.

2. Description of Related Art

Currently, there are many methods used for reducing food deterioration, including but not limited to cold temperature, vacuum cooling, and the replacement of atmospheric air by a gas that does not include Oxygen. Gas replacement, in particular, is generally used for large shipments of produce and is not used for produce aimed directly at the consumer market, since the process works well in bulk volume applications. However, when filling a shipping container with several pallet sized crates of produce, which is often vacuum packaged in plastic bags a method commonly used in pre-packaged salads, crushes the content. Freezing lettuce or pre-packaged salad accelerates deterioration as it thaws. Consequently, there is a need for an method for preserving produce from deterioration while preventing the produce from physical damage.

### BRIEF SUMMARY OF THE INVENTION

In one embodiment of the present invention a method is provided, comprising steps: (a) placing a plurality of produce in an airtight chamber having a quantity of air and a first pressure, wherein the plurality of produce comprises water; (b) removing the quantity of air via a first vacuum pump to reduce the first pressure in the airtight chamber providing a vacuum cooling effect, wherein the water evaporates until the plurality of produce reaches a predetermined temperature; (c) packaging each individual produce of the plurality of produce in a container, wherein the container has a second pressure; (d) reducing the second pressure via a second vacuum pump; and (e) injecting a nitrogen gas inside the container until the container reaches a third pressure.

In one embodiment, in step (c), wherein the container comprises a triangular prism shape having a rectangular base, a pair of opposing triangular faces, a pair of opposing rectangular faces, and a top. In one embodiment, a further step of heat sealing the top of the containers is provided. In another embodiment, the container has a reusable closure system and the top is a re-sealable. In yet another embodiment, the pair of opposing triangular faces guides the pair of opposing rectangular faces to taper towards the top of the container preventing the faces from touching and damaging the produce. In one embodiment, step (d) and step (e) occur simultaneously. In yet another embodiment, the third pressure is lower than the normal atmospheric pressure at sea level.

In one embodiment, the container provides a low oxygen environment to reduce the oxidative process and preserve the individual produce. In one embodiment, the individual produce is a leafy vegetable. In another embodiment, the individual produce is lettuce. In yet another embodiment, in step (b), wherein the predetermined temperature is 1 degree Celsius. In one embodiment, the container is constructed from a polymer, selected from the group consisting of nylon, polyethylene, or a combination thereof. In another embodiment, the container is 3 mm thick. In one embodiment, the container is placed in a sealed compartment equipped with the second vacuum pump.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 illustrates a method for preserving produce according to an embodiment of the present invention.

FIG. 2 illustrates a method for preserving produce according to an embodiment of the present invention.

FIG. 3 illustrates a detailed view of a container according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a method for preserving produce.

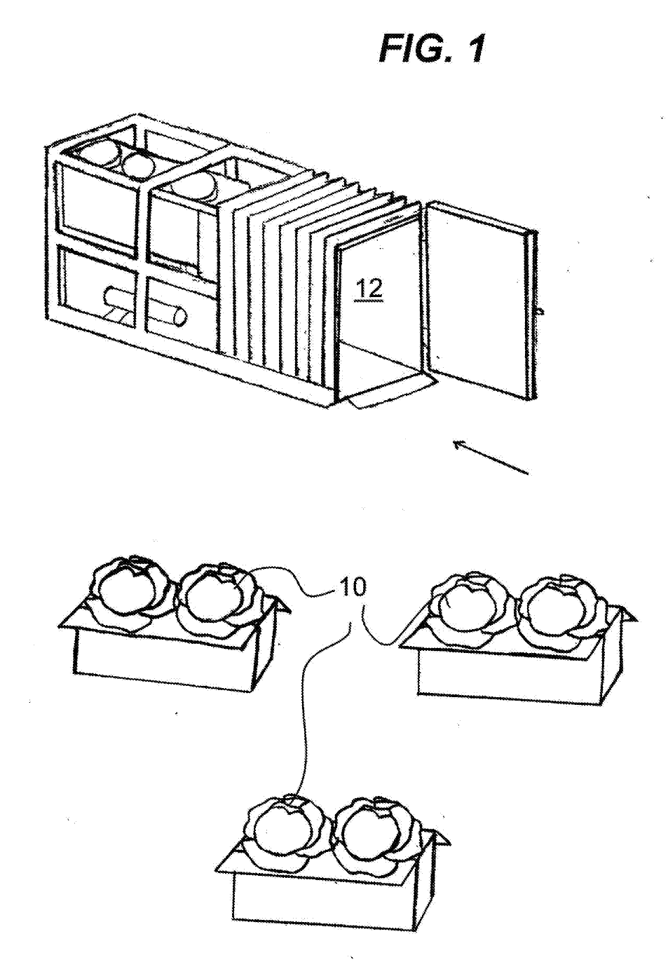

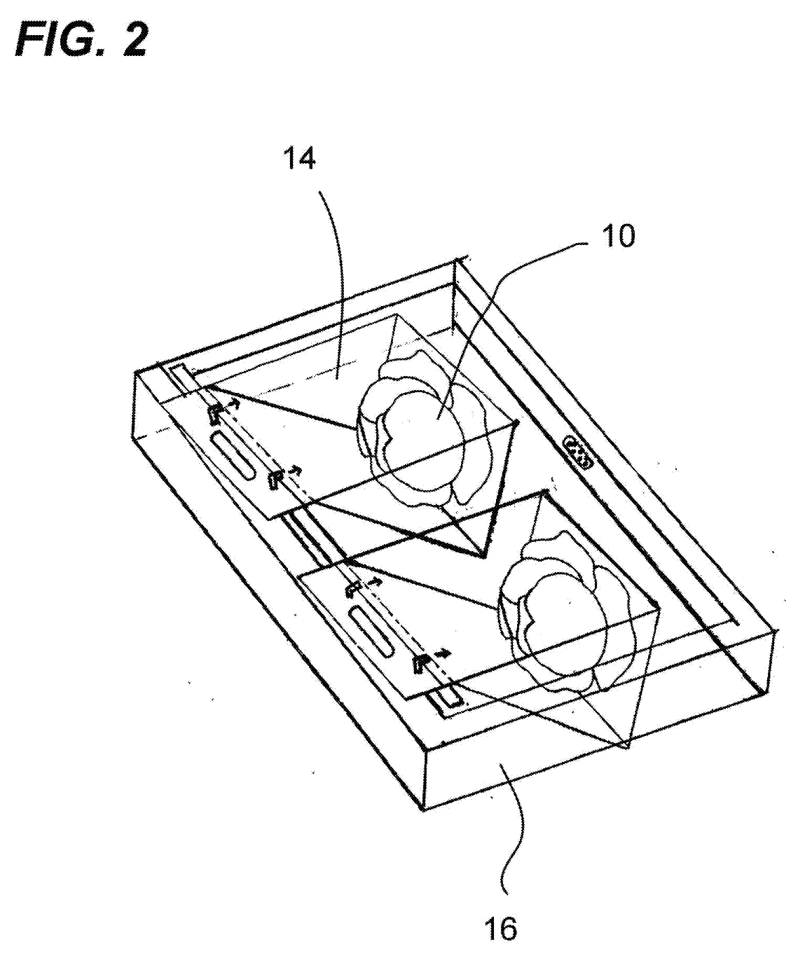

FIGS. 1 and 2 illustrate a method for preserving produce according to an embodiment of the present invention. Referring to FIG. 1, the method comprises a first step of placing a plurality of produce 10 in an airtight chamber 12. In one embodiment, a second step includes vacuum cooling the produce. The second step is carried out by removing the air in the airtight chamber using a vacuum pump. As well known in the art, as the pressure in the chamber is reduced, the boiling point of water decreases, and water starts to evaporate. Consequently, as the result of evaporation, the temperature of the produce beings to decrease. In one embodiment, the process of the second step is carried out until a predetermined temperature, preferably 1 degree Celsius or approximately 34 degrees Fahrenheit, just above freezing. Although not shown, any vacuum pump may be used, as long as the CFM capacity is sufficient in accomplishing the method to decreasing the pressure of the chamber and temperature of the produce to the predetermined temperature.

Referring now to FIG. 2, a third step is provided, wherein each individual produce of the plurality of produce is packaged in a container 14. In one embodiment, the container is sealable and constructed from a polymer, selected from the group consisting of nylon, polyethylene, or a combination thereof. In one embodiment, the container is 3 mm thick. In one embodiment, the container is transparent. In one embodiment, a fourth step includes moving the container, or containers in small batches into a sealed compartment 16 equipped with a second vacuum pump. In one embodiment, a fifth step includes reducing the overall gas pressure inside the containers via the second vacuum pump. Simultaneously, a sixth step includes injecting nitrogen gas inside the containers until the containers reach a pressure that is lower than the normal atmospheric pressure at sea level. Although not shown, any vacuum pump may be used for the second vacuum, as long as the CFM capacity is sufficient in accomplishing the fourth step to reduce the overall gas pressure inside the containers. In one embodiment, a seventh step is provided, wherein the containers are heat sealed using any heat sealing method as well known in the art.

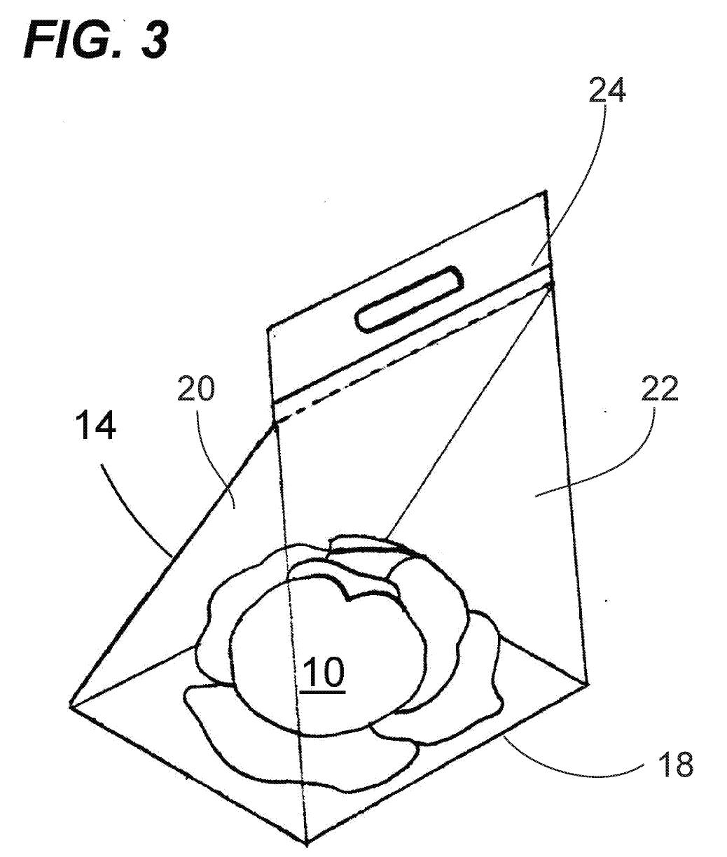

FIG. 3 illustrates a detailed view of a container 14 according to an embodiment of the present invention. Referring to FIG. 3, the container comprises a triangular prism shape having a rectangular base 18, a pair of opposing triangular faces 20, a pair of opposing rectangular faces 22, and a top 24. As previously mentioned, the top was heat sealed in step seven. In one embodiment, the container has a reusable closure system and the top is a re-sealable. Thus after the initial breaking of the original heat seal in step six, the container may be resealed. The pair of opposing triangular faces guides the pair of opposing rectangular faces to taper towards the top of the container. This shape prevents the container faces from damaging the produce, and more specifically, prevents the container faces from pressing up the produce inside the container.

It is a particular object of the present invention to reduce to the oxygen content within the container, as oxygen deteriorates the produce and a low oxygen environment inside the container reduces the oxidative process, and preserves the produce. The method disclosed is most suitable for leafy vegetables, such as lettuce, but it should be understood that the method may be applied to other produce.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A method, comprising steps:
(a) placing a plurality of produce in an airtight chamber having a quantity of air and a first pressure, wherein the plurality of produce comprises water;
(b) removing the quantity of air via a first vacuum pump to reduce the first pressure in the airtight chamber providing a vacuum cooling effect, wherein the water evaporates until the plurality of produce reaches a predetermined temperature;
(c) packaging each individual produce of the plurality of produce in a container, wherein the container has a second pressure;
(d) reducing the second pressure via a second vacuum pump; and
(e) injecting a nitrogen gas inside the container until the container reaches a third pressure.

2. The method of claim 1, in step (c), wherein the container comprises a triangular prism shape having a rectangular base, a pair of opposing triangular faces, a pair of opposing rectangular faces, and a top.

3. The method of claim 2, further comprising a step of heat sealing the top of the containers.

4. The method of claim 3, wherein the container has a reusable closure system and the top is a re-sealable.

5. The method of claim 2, wherein the pair of opposing triangular faces guides the pair of opposing rectangular faces to taper towards the top of the container preventing the faces from touching and damaging the produce.

6. The method of claim 1, wherein step (d) and step (e) occur simultaneously.

7. The method of claim 6, wherein the third pressure is lower than the normal atmospheric pressure at sea level.

8. The method of claim 1, wherein the container provides a low oxygen environment to reduce the oxidative process and preserve the individual produce.

9. The method of claim 8, wherein the individual produce is a leafy vegetable.

10. The method of claim 8, wherein the individual produce is lettuce.

11. The method of claim 1, in step (b), wherein the predetermined temperature is 1 degree Celsius.

12. The method of claim 2, wherein the container is constructed from a polymer, selected from the group consisting of nylon, polyethylene, or a combination thereof.

13. The method of claim 2, wherein the container is 3 mm thick.

14. The method of claim 1, in step (d), wherein the container is placed in a sealed compartment equipped with the second vacuum pump.
